(19) United States
(12) Patent Application Publication
(10) Pub. No.: US 2016/0363682 A1
(43) Pub. Date: Dec. 15, 2016

(54) EFFICIENT SURVEY DESIGN TO IN-FILL A PRE-EXISTING PLURAL VESSELS SEISMIC SURVEY

(71) Applicant: CGG SERVICES SA, Massy (FR)

(72) Inventors: Damien GRENIE, Limours (FR); Keith WILHELM, Houston, TX (US); Yunfeng LI, Houston, TX (US); Michael MEECH, Plymouth (UK)

(21) Appl. No.: 15/176,806

(22) Filed: Jun. 8, 2016

Related U.S. Application Data
(60) Provisional application No. 62/173,403, filed on Jun. 10, 2015.

(51) Int. Cl. G01V 1/38

(52) U.S. Cl. CPC G01V 1/3808

(57) ABSTRACT

Method and system for acquiring seismic data. The method includes receiving an area to be seismically surveyed; receiving a sub-area that is smaller than area; determining a full seismic survey configuration, which includes streamer vessels and source vessels, to survey the entire area, wherein the full seismic survey configuration generates seismic data over the entire area; determining an in-fill process configuration that is different than the full seismic survey configuration, wherein the in-fill process configuration generates long offset seismic data over the sub-area; and sending the full seismic survey configuration to the streamer vessels and the source vessels.

### CROSS REFERENCE TO RELATED APPLICATIONS

The present application claims the benefit of priority under 35 U.S.C. §119(e) to U.S. Provisional Application No. 62/173,403, titled “Efficient Survey Design allowing to Locally in-fill a pre-existing StagSeis Survey,” filed on Jun. 10, 2015, the entire contents being incorporated by reference into the present application.

### TECHNICAL FIELD

Embodiments of the subject matter disclosed herein generally relate to methods and systems for marine seismic data acquisition and, more particularly, to mechanisms and techniques for performing an additional partial survey that allows efficient infill of the missing long offset data in some azimuth sectors of a previous full seismic survey.

### BACKGROUND

Marine seismic data acquisition and processing techniques are used to generate a profile (image) of a geophysical structure (subsurface) under the seafloor. This profile does not necessarily provide an accurate location for oil and gas reservoirs, but it may suggest, to those trained in the field, the presence or absence of oil and/or gas reservoirs. In other words, such an image of the subsurface is a necessary tool today for those drilling exploration wells for minimizing the potential of finding a dry well. Thus, providing a better image of the subsurface is an ongoing process.

For a seismic gathering process, as shown in FIG. 1, a marine seismic data acquisition system 100 includes a survey vessel 102 towing a plurality of streamers 104 (one shown) that may extend over kilometers behind the vessel. One or more source arrays 106 (or simply “source”) may also be towed by the survey vessel 102 or another survey vessel (not shown) for generating seismic waves 108. Conventionally, the source arrays 106 are placed in front of the streamers 104, considering a traveling direction of the survey vessel 102. The seismic waves 108 generated by the source arrays 106 propagate downward and penetrate the seafloor 110, eventually being reflected by a reflecting structure 112, 114, 116, 118 at an interface between different layers of the subsurface, back to the surface 119. The reflected seismic waves 120 propagate upward and are detected by detectors 122 provided on the streamers 104. This process is generally referred to as “shooting” a particular seafloor 110 area.

One of the shortcomings of existing technology relates to the poor azimuth/offset distribution of the data collection points, i.e., detectors 122, positioned along streamers of equal length, and the number of streamers 104 attached to the survey vessel 102. Generally, a single survey vessel 102 tows approximately ten to sixteen streamers 104, of uniform length, with detectors 122 equally spaced along the length of each streamer. In this configuration, the azimuth of the collection points is narrow. The azimuth is defined as the angle made between a line that passes through the source and a recording receiver and the navigation path when viewed from above the source and the recording receiver. Narrow azimuth distribution (typical for a single vessel seismic survey) leads to problems associated with multiple (reflective) removals at locations on the streamers in close proximity to the source arrays 106. It should be noted that a survey vessel is limited in the number of streamers 104 it can tow.

Another shortcoming associated with existing acquisition methods relates to the collected data in relation to its intended use, i.e., different streamer collection configurations lend themselves to different uses of the data, such as multiple removal, imaging and model building. Narrow azimuth distribution streamer configurations are not focused on a specific use of the collected data, resulting in less than optimal seismic image results.

An acquisition method having better azimuth and offset distribution than the system shown in FIG. 1 is illustrated in FIG. 2 (which corresponds to FIG. 4 of U.S. patent application Ser. No. 14/902,926, the entire content of which is incorporated by reference herein), in which a seismic survey system 200 includes two streamer vessels 202 and 204 and three source vessels 206, 208 and 210. The streamer vessels 202 and 204 are towing corresponding streamer spreads 202B and 204B, and optionally, one or more seismic source arrays 202A and 204A. A source array may include one or more sub-arrays and a sub-array may include one or more source elements. A source element may be an air gun, a vibratory element, etc. A streamer vessel necessarily tows a streamer spread while a source vessel necessarily tows a source array. However, it is possible that the streamer vessel also tows a source array, as illustrated in FIG. 2.

The marine acquisition system illustrated in FIG. 2 is known as a StagSeis configuration, i.e., the sources are staggered both along the inline direction X and the cross-line direction Y. The StagSeis configuration may have the sources distributed along a curved line 220. In one application, line 220 is a straight line, slanted or not relative to the advancing path of the vessels.

Traditionally, a StagSeis acquisition follows substantially perpendicular pre-plot paths 330 and 332 as illustrated in FIG. 3A. In one application, the system 200 shown in FIG. 2 is towed along the first pre-plot path 330 during a first pass, then opposite the first pre-plot path 330 during a second pass, along the second pre-plot path 332 during a third pass and opposite the second pre-plot path 332 during a fourth path. The seismic data collected during these four passes is illustrated in FIG. 3B, which is a rose diagram plotting the amplitude versus azimuth distribution, where the amplitude is larger as the image is darker and the azimuth angle is indicated on the graph. FIG. 3C plots the same seismic data as an offset histogram, i.e., a number of traces N recorded for each offset between a source and a seismic receiver.

One will note in FIG. 3B that the long offsets are missing in the four regions Q1-Q4 at a 45 degree angle and also in region 390 of FIG. 3C.

Accordingly, it would be desirable to provide systems and methods that further reduce the azimuth gaps and provide long offsets for all directions of the seismic survey to improve an accuracy of the subsurface's image.

### SUMMARY

According to an embodiment, there is a method for configuring a marine seismic acquisition system. The method includes receiving an area to be seismically surveyed; receiving a sub-area that is smaller than area; determining a full seismic survey configuration, which includes streamer vessels and source vessels, to survey the entire area, wherein the full seismic survey configuration generates seismic data over the entire area; determining an in-fill process configuration that is different than the full seismic survey configuration, wherein the in-fill process configuration generates long offset seismic data over the sub-area; and sending the full seismic survey configuration to the streamer vessels and the source vessels.

According to another embodiment, there is a system for collecting seismic data. The system includes plural source vessels that tow plural source arrays over a given survey area for generating seismic waves; and plural streamer vessels that tow plural streamer spreads over the given survey area for recording seismic data, wherein the plural source vessels and the plural streamer vessels follow a first pre-plot path and a second pre-plot path, substantially perpendicular to the first pre-plot. A subset of the plural source vessels and a subset of the plural streamer vessels are later driven to collect long offset seismic data in a sub-area located within the survey area. The subset of source vessels and the subset of streamer vessels follow a third pre-plot path and a fourth pre-plot path, and the first pre-plot path makes a non-zero angle with the third pre-plot path and the second pre-plot path makes the non-zero angle with the fourth pre-plot path.

According to yet another embodiment, there is a method for establishing primary and secondary pre-plot paths for a seismic survey campaign. The method includes selecting a first set of streamer vessels to collect seismic data for a full seismic survey; selecting a second set of source vessels to perform the full seismic survey; choosing first and second pre-plot paths for the streamer and source vessels, where the first and second pre-plot paths are perpendicular to each other, wherein the first and second pre-plot paths cover an entire area to be surveyed; estimating a sub-area within the area to be surveyed; selecting a first subset of the first set of streamer vessels to perform an in-fill process of collecting additional seismic data only for the sub-area; selecting a second subset of the second set of source vessels to perform the in-fill process; choosing third and fourth pre-plot paths for the first and second subsets of streamer and source vessels, where the third and fourth pre-plot paths are perpendicular to each other, wherein the third and fourth pre-plot paths cover only the sub-area; and instructing the streamer vessels and the source vessels to follow the first and second pre-plot paths first and the third and fourth pre-plots paths second. The third and fourth pre-plot paths are rotated relative to the first and second pre-plot paths.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of a traditional marine seismic data acquisition system;

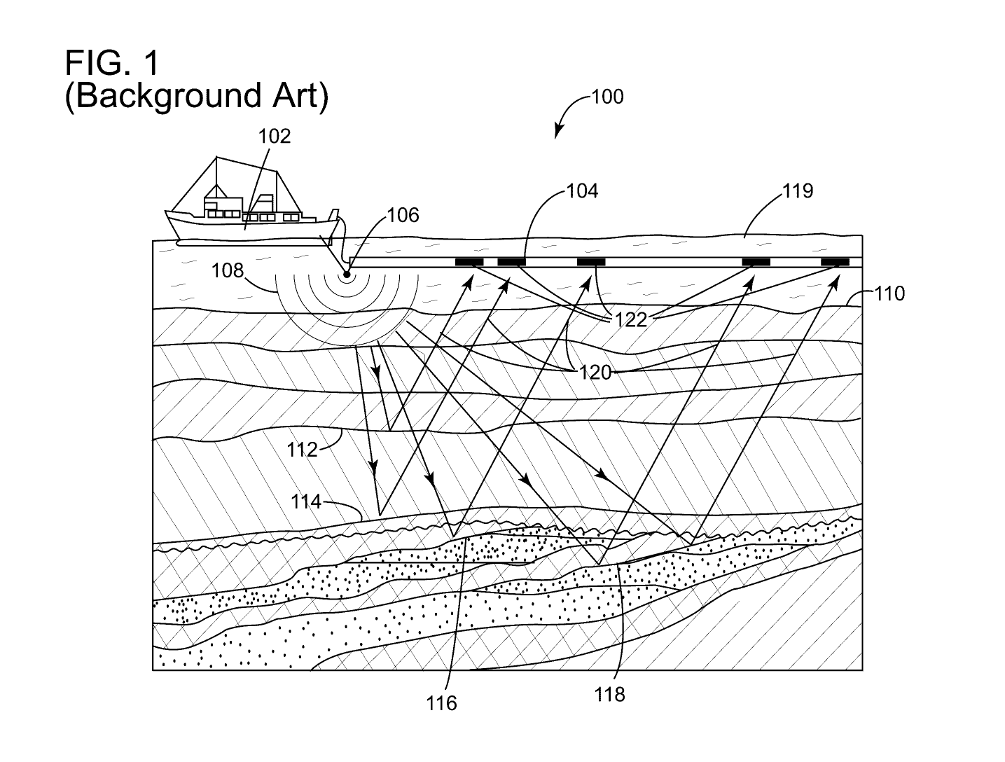

FIG. 2 is a schematic illustration of a multi-vessel marine seismic data acquisition system;

FIGS. 3A-3C illustrate a multi-vessel marine seismic system and the acquired seismic data missing long offsets portions at certain azimuths;

FIG. 4 shows a full seismic survey configuration and an in-fill process configuration;

FIGS. 5A-5C illustrate a reduced vessel marine seismic system and the acquired seismic data being reach in long offsets portions at certain azimuths;

FIGS. 6A-6B show the seismic data acquired with the full seismic survey configuration and the in-fill process configuration being reach in all long offsets portions;

FIG. 7 is a flowchart of a method for configuring a marine seismic acquisition system to acquire seismic data with a full seismic survey configuration and an in-fill process configuration;

FIG. 8 is a flowchart of a method for establishing primary and secondary pre-plot paths for a seismic survey campaign that includes a full seismic survey configuration and an in-fill process configuration; and

FIG. 9 is a schematic illustration of a computing device to implement various methods described herein.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of one streamer vessels and two source vessels. However, the embodiments to be discussed next are not limited to this configuration, but may be extended to other arrangements that include more or fewer streamer vessels and/or source vessels. Also, the figures show a particular order of the streamer and source vessels along inline and cross-line directions. This order is exemplary and not intended to limit the embodiments.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, after a full seismic survey has been performed with a full seismic survey configuration, an in-fill process is performed, with a an in-fill process configuration, in one or more areas of the original seismic survey area, for adding long offsets seismic data to the initially collected seismic data. The pre-plot paths followed during the in-fill process make substantially a non-zero angle with the pre-plot paths followed during the full seismic survey. In the following, the term “full seismic survey” is understood to mean shooting sources while traversing an entire seismic survey area (typically in the order of hundreds to hundreds of thousands of square kilometers) and recording seismic data with seismic sensors located in the spread. The term “spread” means one or more streamers or one or more underwater vehicles that carry seismic sensors. The term “in-fill process” is understood herein to mean shooting sources while traversing a sub-area of the seismic survey area (i.e., a smaller area), and also recording seismic data with seismic sensors for the sub-area. The in-fill process is expected to take place after the full seismic survey of the seismic area has been performed. The full seismic survey and the in-fill process are not the same as a 4D seismic survey, in which a base survey is performed first and then a monitor survey is performed later over the exact same survey area. While the base and monitor surveys indicate a temporal change in the characteristics of the surveyed subsurface and both the base and monitor surveys shot the entire survey area, the full seismic survey and the in-fill process provide seismic information which is assumed to be at the same time (although a small time difference exists between the two actions) and the in-fill process covers an area less than the one covered by the full seismic survey. Also, the vessels, sources and streamers configurations for the latter case changes from one survey to another while the same configurations are used for the base and monitors of a 4D seismic survey.

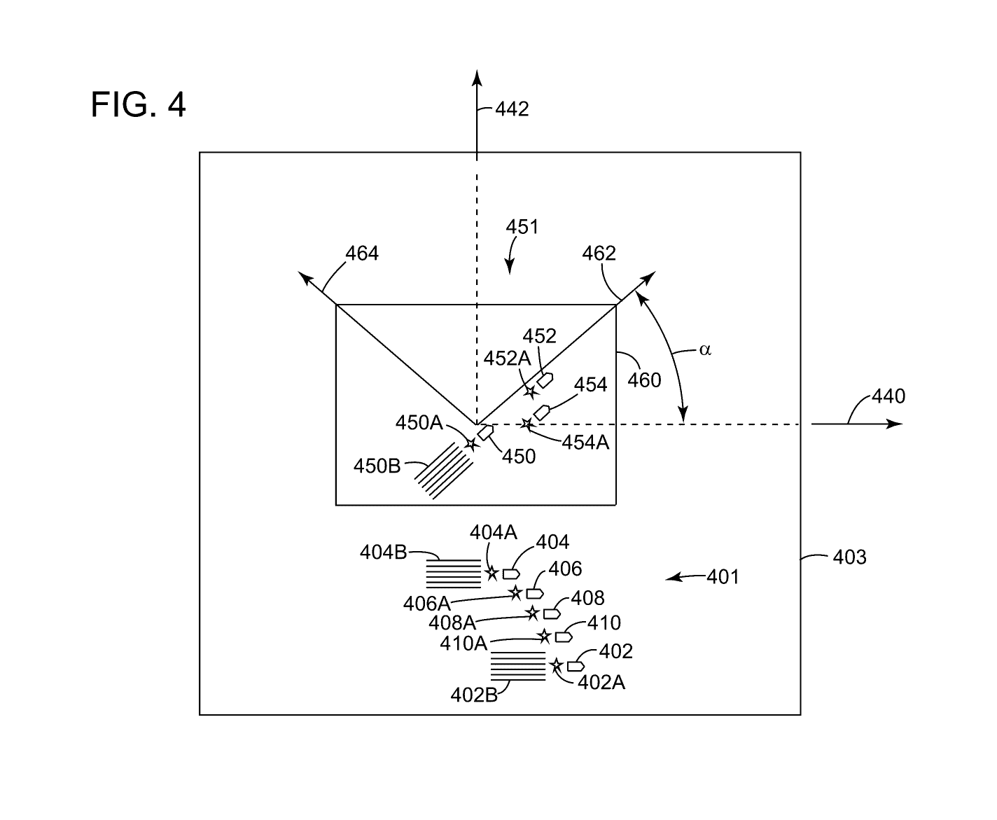

These configurations are now discussed in more detail. According to an embodiment, FIG. 4 illustrates a full seismic survey configuration 401 and an in-fill process configuration 451. Although FIG. 4 gives the impression that the two surveys take place at the same time, the full seismic survey configuration 401 surveys first the survey area 403 and the in-fill process configuration 451 surveys, later in time, only a sub-area 460 of the survey area 403. Sub-area 460 is smaller than survey area 403. In one embodiment, the sub-area 460 is made of plural small areas that are not continuous one to the other.

The full seismic survey configuration 401 is used to survey the entire survey area 403 while the in-fill process configuration 451 is used to survey only the sub-area 460. The in-fill process configuration 451 is smaller than the full seismic survey configuration 401 in terms of at least one parameter, i.e., the in-fill process configuration 451 includes less vessels, or less sources or less streamer spreads than the full seismic survey configuration.

Sub-area 460 is strategically chosen by the operator of the survey and its size and location relative to the full survey area 403 depends from survey to survey. The sub-area is chosen inside the full survey area 403. Although FIG. 4 shows the two areas 403 and 460 to be rectangular, these two areas may have any shape. In addition, the two shapes may be different.

FIG. 4 shows two pre-plot paths 440 and 442 followed by the vessels during the full seismic survey. The two pre-plot paths coincide with the inline direction and the cross-line direction for the full seismic survey configuration 401. Traditionally, the inline direction is considered to be the vessel's advancement direction and the cross-line direction is considered to be perpendicular on the inline direction.

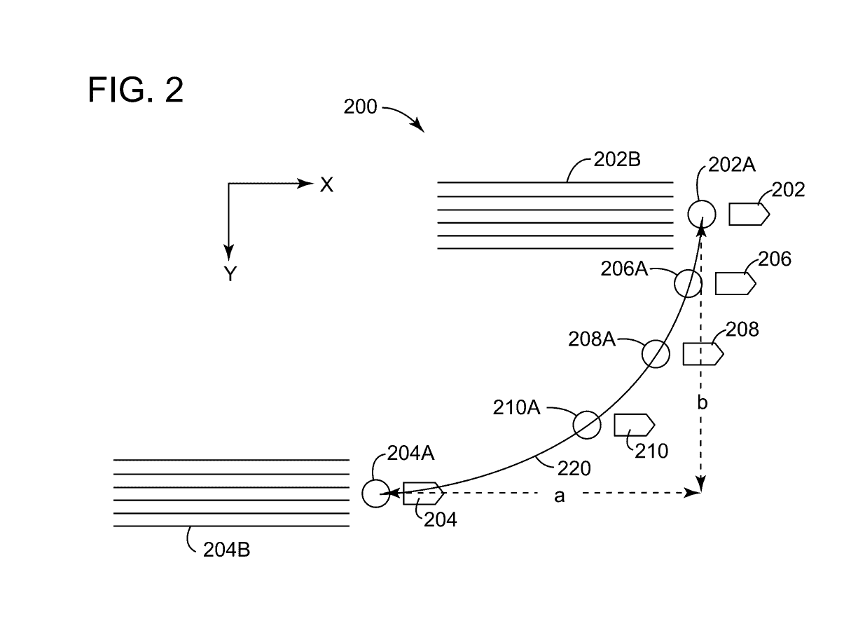

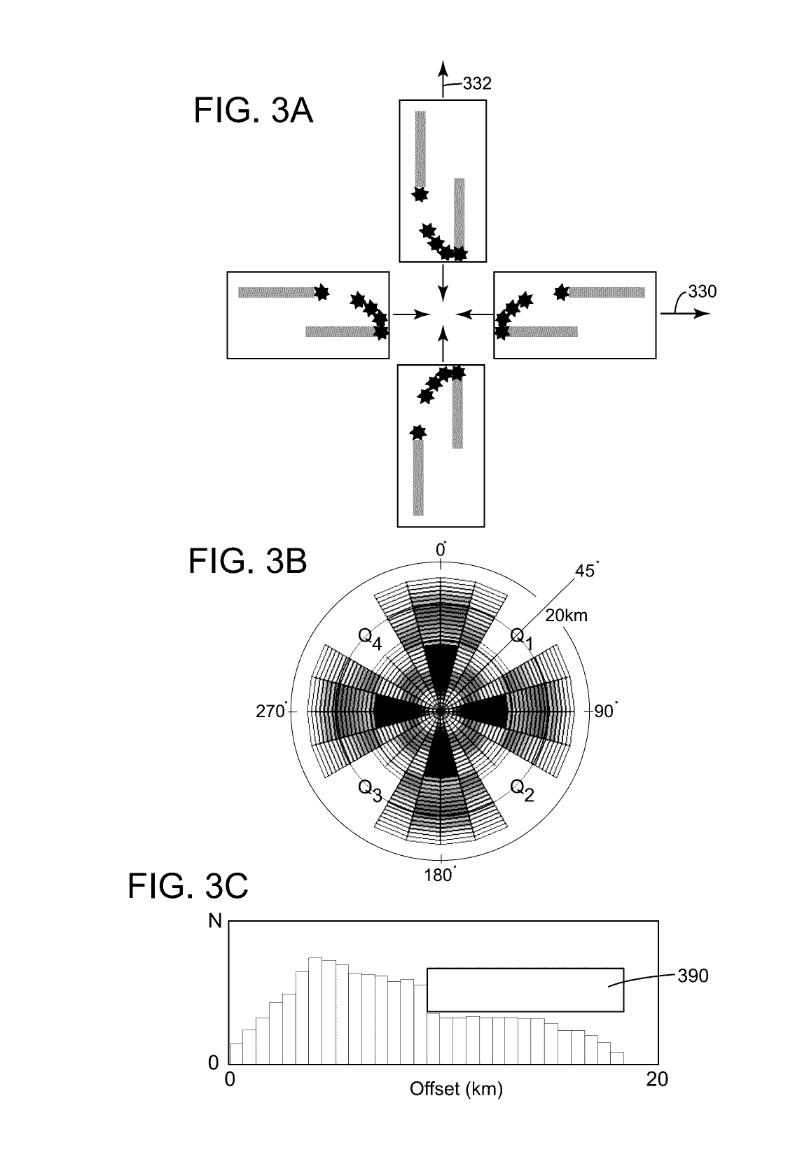

The full seismic survey configuration 401 is shown to include two streamer vessels 402 and 404, each vessel towing a source 402A and 404A, respectively, and each vessel towing a streamer spread 402B and 404B, respectively. Source vessels 406, 408 and 410 are shown towing corresponding sources 406A, 408A and 410A. The sources are located on a curved line, similar to the configuration illustrated in FIG. 2. The curved line may be any parametrized line, i.e., a line that can be described with a parametric equation. The full seismic survey configuration 401 is run along the first pre-plot path 440 with various cross-line values along the second pre-plot path 442 until the entire survey area 403 is surveyed. The full seismic survey configuration 401 can then be run along the second pre-plot path 442 with various cross-line values along the first pre-plot path 442 until the entire survey area is surveyed. The full seismic survey configuration 401 is a StagSeis configuration as in the embodiment illustrated in FIG. 3A.

Next, the sub-area 460 is selected to be inside the full survey area 403. Third and fourth pre-plot paths 462 and 464 are selected that make a given angle with the first and second pre-plot paths 440 and 442. More specifically, the third pre-plot path 462 makes an angle a with the first pre-plot path 440 and the fourth pre-plot path 464 makes the same angle a with the second pre-plot path 442. The angle α is preferably 45°. However, in one embodiment, the angle is larger than zero and smaller than 90°.

The in-fill process configuration 451 is run only for the sub-area 460. Although the in-fill process configuration 451 is run after the full seismic survey, in one embodiment, the in-fill process configuration 451 may be run first and then the full seismic survey. If the survey area 403 is large enough so that seismic waves generated by the full seismic survey configuration do not interfere with the in-fill process configuration, the two configurations may be run in parallel.

The in-fill process configuration 451 includes, as illustrated in FIG. 4, a streamer vessel 450 that tows a source 450A and a streamer spread 450B. The streamer vessel 450 may be one of the streamer vessels 402 or 404 or another streamer vessel. The source vessels 452 and 454 may be the source vessels 406, 408 and 410 or other source vessels. Ahead of the streamer vessel 450, along the third pre-plot path 462 (which now is the inline direction for the in-fill process configuration), two source vessels 452 and 454 tow corresponding sources 452A and 454A. The two sources may have the same or different inline positions (relative to the third pre-plot path 462). If they have different inline positions, the in-fill process configuration 451 is a smaller size StagSeis configuration.

After the in-fill process configuration 451 makes one pass along the third pre-plot path 462 and reaches the boundary of the sub-area 460, the vessels turn around and make a second pass along an opposite direction of the third pre-plot path 462 or along the fourth pre-plot path 464. Similar to the embodiment of FIG. 3A, the in-fill process configuration 451 can make multiple passes along the third and/or fourth pre-plot paths before moving to a new path for surveying the entire sub-area 451.

While the embodiment of FIG. 4 shows the in-fill process configuration 451 including three vessels, it is possible to use more or less source vessels, more streamer vessels, and the source vessels may be placed in different locations (e.g., lateral or behind) relative to the streamer spread.

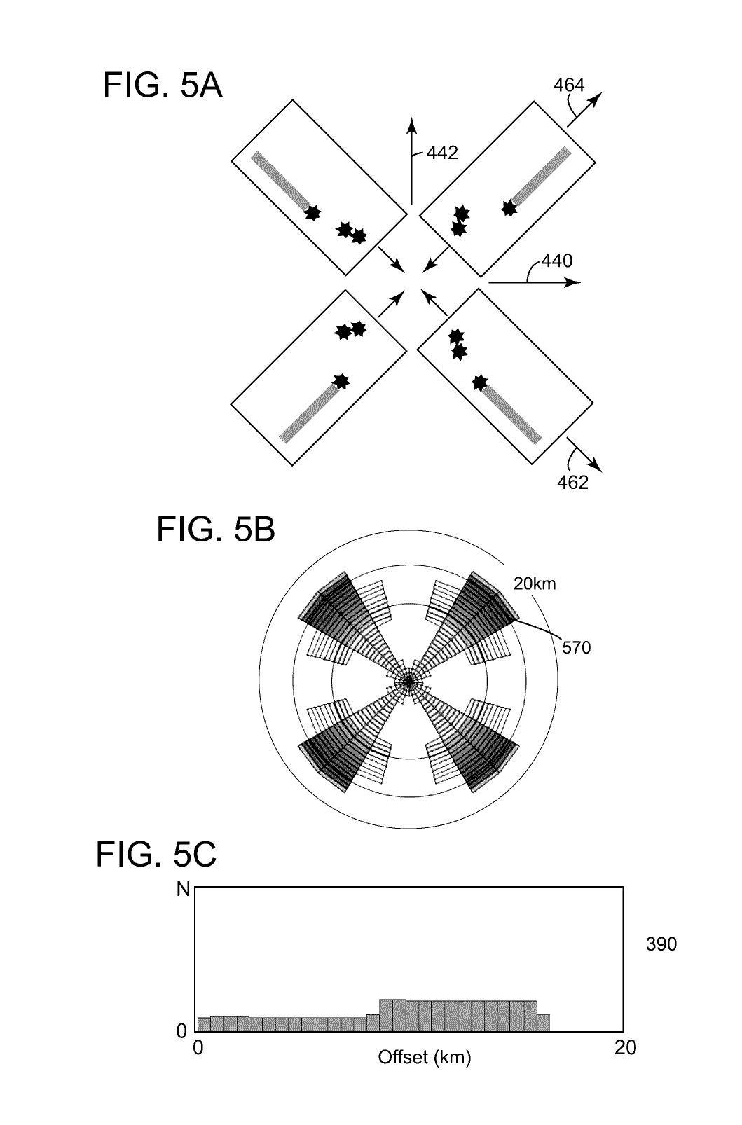

The seismic data collected with the in-fill process configuration 451 is now discussed with regard to FIGS. 5A-5C. FIG. 5A schematically shows the configuration of FIG. 4 making four passes, two passes for each of the third and fourth pre-plot path 462 and 464. Also, the configuration in FIG. 5A has the angle α substantially equal to 45°. Note that a deviation of about 10% from this value is considered to be within the definition of the term “substantially.” FIG. 5B is a rose diagram of the amplitude versus azimuth for the seismic data acquired with the in-fill process configuration 451. Note that long-offsets 570 at 45° are recorded as illustrated in FIG. 5B. FIG. 5C shows the same data as an offset histogram. The configuration shown in FIG. 5A involves only three sources and one streamer vessel and thus, it saves one streamer vessel and two sources compared to the StagSeis configuration of FIG. 3A while allowing a similar quality of seismic data acquisition.

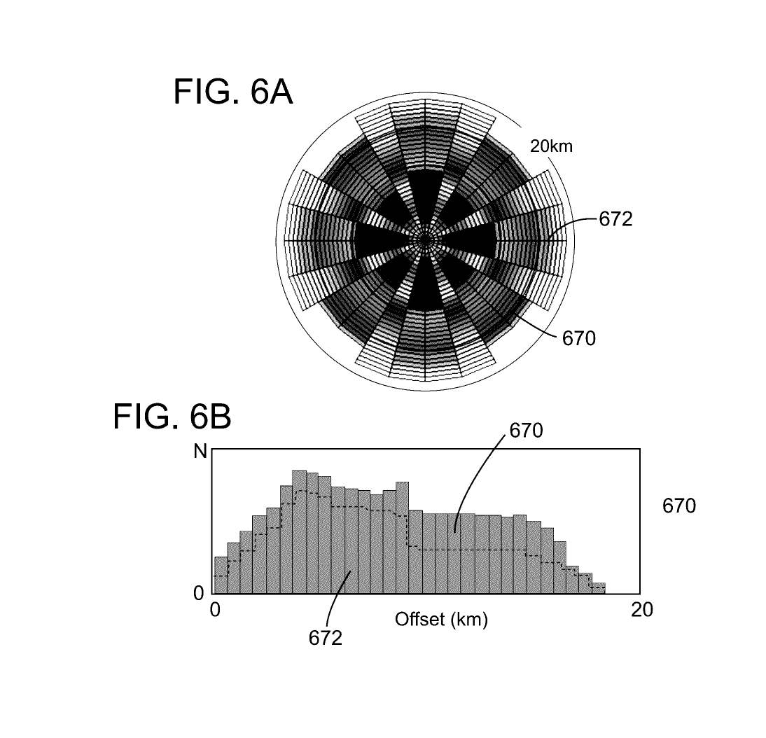

If the seismic data acquired with the full seismic survey configuration 401 is superimposed with the seismic data acquired with the in-fill process configuration 451, as illustrated in FIG. 6A, the missing long offsets 390 (see FIG. 3C) of the StagSeis configuration are efficiently filled as illustrated in the rose diagram. FIG. 6B, which is the offset histogram, also shows the long offset seismic data 670 complementing the seismic data 672 acquired with the full seismic survey configuration 401.

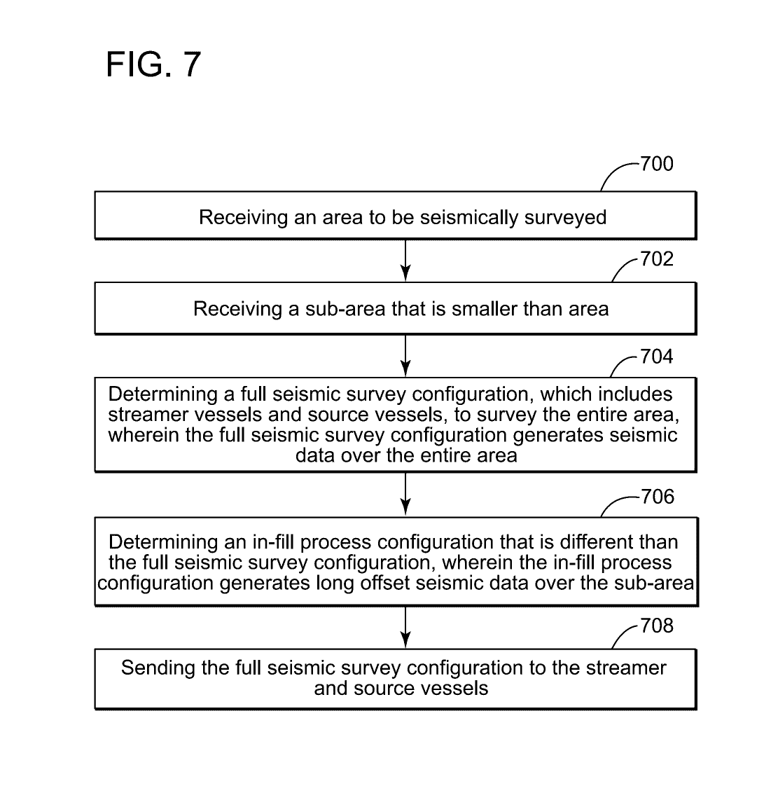

A method that implements the above discussed full seismic survey configuration and the in-fill process configuration is now discussed with regard to FIG. 7. FIG. 7 is a flow-chart of a method for configuring a marine seismic acquisition system. The method includes a step 700 of receiving an area to be seismically surveyed, a step 702 of receiving a sub-area that is smaller than area, a step 704 of determining a full seismic survey configuration, which includes streamer vessels and source vessels, to survey the entire area, wherein the full seismic survey configuration generates seismic data over the entire area; a step 706 of determining an in-fill process configuration that is different than the full seismic survey configuration, wherein the in-fill process configuration generates long offset seismic data over the sub-area, and a step 708 of sending the full seismic survey configuration to the streamer and source vessels.

In this method, the in-fill process configuration may includes less streamer vessels than the full seismic survey configuration, or the in-fill process configuration may include less source vessels than the full seismic survey configuration, or the in-fill process configuration may includes less streamer vessels and less source vessels than the full seismic survey configuration.

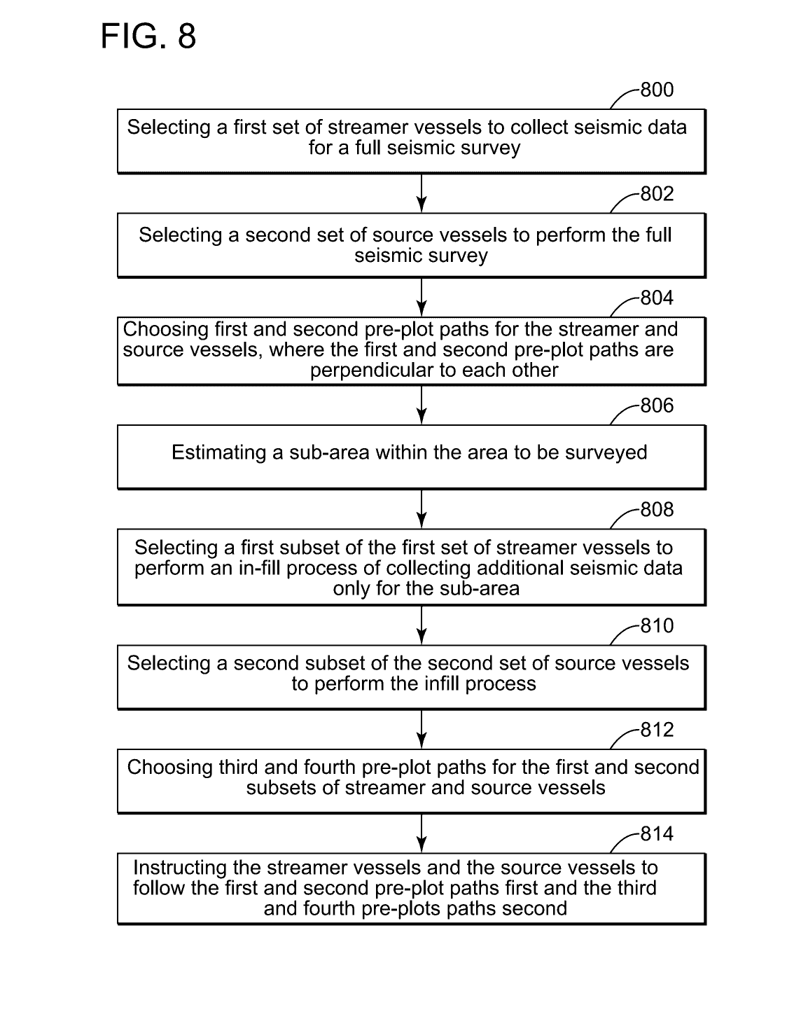

In another embodiment illustrated in FIG. 8, a method for establishing primary and secondary pre-plot paths for a seismic survey campaign is discussed. The seismic survey campaign uses a full seismic survey configuration to cover the area to be surveyed and an in-fill process configuration, which is reduced relative to the full seismic survey configuration, to cover only a sub-area of the area to be surveyed. The primary pre-plot paths include first and second pre-plot paths for the full seismic survey configuration, and the secondary pre-plot paths include third and fourth pre-plot paths for the in-fill seismic survey configuration.

The method includes a step 800 of selecting a first set of streamer vessels to collect seismic data for a full seismic survey, a step 802 of selecting a second set of source vessels to perform the full seismic survey, a step 804 of choosing first and second pre-plot paths for the streamer and source vessels, where the first and second pre-plot paths are perpendicular to each other and the first and second pre-plot paths cover an entire area to be surveyed, a step 806 of estimating a sub-area within the area to be surveyed, a step 808 of selecting a first subset of the first set of streamer vessels to perform an in-fill process of collecting additional seismic data only for the sub-area, a step 808 of selecting a second subset of the second set of source vessels to perform the in-fill process, step 810 of choosing third and fourth pre-plot paths for the first and second subsets of streamer and source vessels, where the third and fourth pre-plot paths are perpendicular to each other and the third and fourth pre-plot paths cover only the sub-area, and a step 812 of instructing the streamer vessels and the source vessels to follow the first and second pre-plot paths first and the third and fourth pre-plots paths second. The third and fourth pre-plot paths are rotated relative to the first and second pre-plot paths.

In one application, the third and fourth pre-plot paths are rotated with 45 degrees relative to the first and second pre-plot paths, respectively. In another application, the long offset seismic data is added to the seismic data for imaging a subsurface. In still another application, the first set of streamer vessels includes two vessels, the first set of source vessels includes three vessels, the first subset of streamer vessels includes one vessel, and the second subset of source vessels includes two vessels. In another application, the first set of streamer vessels and the second set of source vessels are located along a curved line.

The vessels discussed above may follow straight paths (pre-plot sail lines) or curved paths having amplitudes, periods and phases that may or may not be the same. The amplitudes, periods, and phases for the curved paths may be optimized to obtain better azimuth and offset diversity for the recorded data. However, it is possible that only the streamer vessels follow the curved path and the source vessels follow a straight line path, or the other way around, or any other combination, as long as the azimuth and/or offset distribution of the collected seismic data is improved relative to the existing acquisition systems, see for example, U.S Patent Application Publication No. 2013/0188448.

Regarding the streamers, it is possible to have various seismic sensors located on the streamer to record the seismic data. For example, the streamers may include hydrophones, geophones, accelerometers, optical fiber, or a combination of them. The streamers may have different lengths and the number of streamers may differ. The streamer spreads 402B and 450B may be different or the same.

Regarding the sources, it is conventional to tow a source array that includes three sub-arrays. Each sub-array includes a float to which individual source elements are attached. Thus, all the individual source elements may be located at a same or different depth. It is also possible that each vessel tows two or more source arrays.

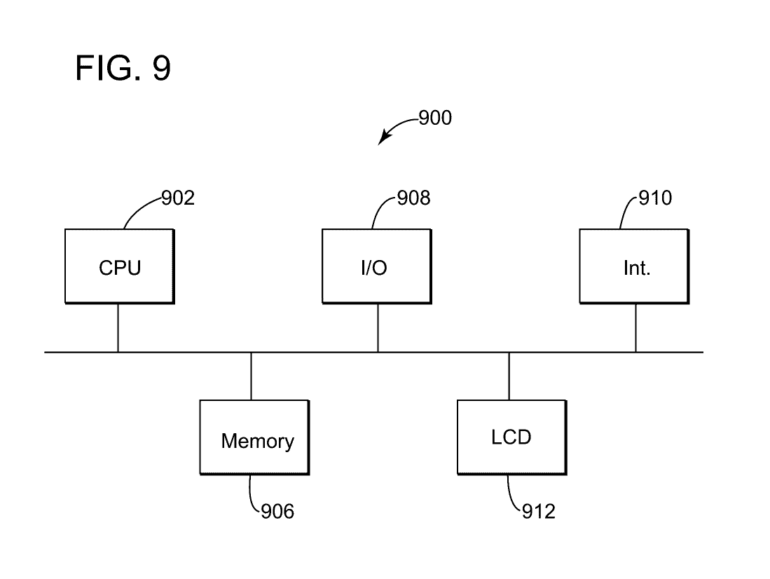

The methods and algorithms discussed above may be implemented in a computing device 800 as illustrated in FIG. 9. The computing device 900 may be a processor, a computer, a server, etc. The computing device 900 may include a processor 902 connected through a bus 904 to a storage device 906. The storage device 906 may be any type of memory and may store necessary commands and instructions associated with positioning the sources and the streamer spreads as discussed above. Also connected to the bus 904 is an input/output interface 908 through which the operator may interact with the sources, for example, for locating the sources on a desired non-linear profile as illustrated in FIG. 2. A communication interface 910 is also connected to the bus 904 and is configured to transfer information between the processor 902 and an outside network, Internet, operator's internal network, etc. The communication interface 910 may be wired or wireless. Optionally, computing device 900 may include a screen 912 for displaying various results generated by the algorithms discussed above. For example, the positions of the sources may be displayed, after being calculated with the novel algorithms, on the screen 912.

The above-disclosed embodiments provide a system and a method for improving an azimuth and/or offset distribution for a seismic survey. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for configuring a marine seismic acquisition system, the method comprising:
receiving an area to be seismically surveyed;
receiving a sub-area that is smaller than the area;
determining a full seismic survey configuration, which includes streamer vessels and source vessels, to survey the entire area, wherein the full seismic survey configuration generates seismic data over the entire area;
determining an in-fill process configuration that is different than the full seismic survey configuration, wherein the in-fill process configuration generates long offset seismic data over the sub-area; and
sending the full seismic survey configuration to the streamer vessels and the source vessels.

2. The method of claim 1, wherein an inline direction of the in-fill process configuration makes a non-zero angle with an inline direction of the full seismic survey configuration.

3. The method of claim 2, wherein the angle is 45 degrees.

4. The method of claim 1, wherein the long offset seismic data is added to the seismic data for imaging a subsurface.

5. The method of claim 1, wherein the in-fill process configuration includes less streamer vessels than the full seismic survey configuration.

6. The method of claim 1, wherein the in-fill process configuration includes less source vessels than the full seismic survey configuration.

7. The method of claim 1, wherein the in-fill process configuration includes less streamer vessels and less source vessels than the full seismic survey configuration.

8. The method of claim 1, wherein the streamer vessels and the source vessels are staggered with respect to each other both along an inline direction and a cross-line direction for the full seismic survey configuration and for the in-fill process configuration.

9. The method of claim 1, wherein the streamer vessels and the source vessels are located along a curved line.

10. The method of claim 1, wherein the full seismic survey configuration uses two streamer vessels and three source vessels and the in-fill process configuration uses one streamer vessel and two source vessels.

11. A system for collecting seismic data comprising:
plural source vessels that tow plural source arrays over a given survey area for generating seismic waves; and
plural streamer vessels that tow plural streamer spreads over the given survey area for recording seismic data, wherein the plural source vessels and the plural streamer vessels follow a first pre-plot path and a second pre-plot path, substantially perpendicular to the first pre-plot,
wherein a subset of the plural source vessels and a subset of the plural streamer vessels are later driven to collect long offset seismic data in a sub-area located within the survey area,
wherein the subset of source vessels and the subset of streamer vessels follow a third pre-plot path and a fourth pre-plot path, and
wherein the first pre-plot path makes a non-zero angle with the third pre-plot path and the second pre-plot path makes the non-zero angle with the fourth pre-plot path.

12. The system of claim 11, wherein the angle is 45 degrees.

13. The system of claim 11, wherein the long offset seismic data is added to the seismic data for imaging a subsurface.

14. The system of claim 11, wherein the plural streamer vessels and the plural source vessels are staggered with respect to each other along the first and second pre-plot paths.

15. The system of claim 11, wherein the plural streamer vessels and the plural source vessels are located along a curved line while acquiring the seismic data.

16. A method for establishing primary and secondary pre-plot paths for a seismic survey campaign, the method comprising:
selecting a first set of streamer vessels to collect seismic data for a full seismic survey;
selecting a second set of source vessels to perform the full seismic survey;
choosing first and second pre-plot paths for the streamer and source vessels, where the first and second pre-plot paths are perpendicular to each other, wherein the first and second pre-plot paths cover an entire area to be surveyed;
estimating a sub-area within the area to be surveyed;
selecting a first subset of the first set of streamer vessels to perform an in-fill process of collecting additional seismic data only for the sub-area;
selecting a second subset of the second set of source vessels to perform the in-fill process;
choosing third and fourth pre-plot paths for the first and second subsets of streamer and source vessels, where the third and fourth pre-plot paths are perpendicular to each other, wherein the third and fourth pre-plot paths cover only the sub-area; and
instructing the streamer vessels and the source vessels to follow the first and second pre-plot paths first and the third and fourth pre-plots paths second,
wherein the third and fourth pre-plot paths are rotated relative to the first and second pre-plot paths.

17. The method of claim 16, wherein third and fourth pre-plot paths are rotated with 45 degrees relative to the first and second pre-plot paths, respectively.

18. The method of claim 16, wherein the long offset seismic data is added to the seismic data for imaging a subsurface.

19. The method of claim 16, wherein the first set of streamer vessels includes two vessels, the first set of source vessels includes three vessels, the first subset of streamer vessels includes one vessel, and the second subset of source vessels includes two vessels.

20. The method of claim 16, wherein the first set of streamer vessels and the second set of source vessels are located along a curved line.
